(19) United States
(12) Patent Application Publication
(10) Pub. No.: US 2022/0215692 A1
(43) Pub. Date: Jul. 7, 2022

(54) OPERATION-CORRECTNESS DETERMINING APPARATUS AND OPERATION-CORRECTNESS DETERMINING METHOD

(71) Applicant: SUBARU CORPORATION, Tokyo (JP)

(72) Inventors: Tomoki HOSOTANI, Tokyo (JP); Shinichirou OKINO, Tokyo (JP)

(21) Appl. No.: 17/563,596

(22) Filed: Dec. 28, 2021

(30) Foreign Application Priority Data
Jan. 6, 2021 (JP) 2021-000947

(51) Int. Cl. G06V 40/20; G06T 7/246; G06V 10/25

(52) U.S. Cl. CPC G06V 40/28; G06V 10/25; G06T 7/246

(57) ABSTRACT

An operation-correctness determining apparatus capable of determining whether a predetermined operation has been performed correctly includes a wearable camera, a target object detector, a hand skeleton detector, a motion detector, and an operation-correctness determiner. The wearable camera captures a region larger than or substantially equal to an operator's field of view. The target object detector detects a target object within a captured region captured by the wearable camera. The hand skeleton detector detects an operator's hand skeleton within the captured region. The motion detector detects an operator's hand behavior from time series variation of the detected target object and from time series variation of the detected operator's hand skeleton. The operation-correctness determiner determines whether at least the detected target object and the detected operator's hand behavior substantially match a pre-learned target object and a pre-learned operator's hand behavior, and if so, determines that the predetermined operation has been performed correctly.

### CROSS-REFERENCE TO RELATED APPLICATIONS

The present application claims priority from Japanese Patent Application No. 2021-000947 filed on Jan. 6, 2021, the entire contents of which are hereby incorporated by reference.

### BACKGROUND

The disclosure relates to an operation-correctness determining apparatus and an operation-correctness determining method. For example, the disclosure relates to an operation-correctness determining apparatus and an operation-correctness determining method for, if an operator performs a predetermined operation on a predetermined target object by hand, determining whether the operation has been performed correctly.

For instance, in manufacturing, image analysis (image recognition) technology is beginning to find applications in devices and methods that, in performing a predetermined operation on a predetermined target object, determine whether the operation has been performed correctly. One such exemplary application is described in International Publication No. WO 2018/062238A1, in which if an operator is determined to be performing an irregular operation different from a standard operation (inspection), an image of the operation being performed is captured by a wearable camera worn by the operator. WO 2018/062238A1 describes that whether a workpiece to be inspected that has been captured by the wearable camera is a conforming item is determined based on the captured image.

### SUMMARY

An aspect of the disclosure provides an operation-correctness determining apparatus capable of determining whether a predetermined operation has been performed correctly. The predetermined operation is an operation that an operator performs on a target object defined in advance by hand. The operation-correctness determining apparatus includes a wearable camera, a target object detector, a hand skeleton detector, a motion detector, and an operation-correctness determiner. The wearable camera is capable of capturing a region larger than or substantially equal to a field of view of the operator. The target object detector is configured to detect the target object within a captured region captured by the wearable camera. The hand skeleton detector is configured to detect an operator's hand skeleton within the captured region. The operator's hand skeleton is a skeleton of a hand of the operator. The motion detector is configured to detect an operator's hand behavior from time series variation of the target object detected by the target object detector and from time series variation of the operator's hand skeleton detected by the hand skeleton detector. The operator's hand behavior is a behavior of the hand of the operator. The operation-correctness determiner is configured to determine whether at least the target object detected by the target object detector and the operator's hand behavior detected by the motion detector substantially match a pre-learned target object and a pre-learned operator's hand behavior. Upon determining that the detected target object and the detected operator's hand behavior substantially match the pre-learned target object and the pre-learned operator's hand behavior, the operation-correctness determiner is configured to determine that the predetermined operation has been performed correctly. The pre-learned target object is the target object that is previously learned. The pre-learned operator's hand behavior is the operator's hand behavior that is previously learned.

An aspect of the disclosure provides an operation-correctness determining method for determining whether a predetermined operation has been performed correctly. The predetermined operation is an operation that an operator performs on a target object defined in advance by hand. The operation-correctness determining method includes detecting the target object within a captured region captured by a wearable camera. The wearable camera is capable of capturing a region larger than or substantially equal to a field of view of the operator. The operation-correctness determining method includes detecting an operator's hand skeleton within the captured region. The operator's hand skeleton is a skeleton of a hand of the operator. The operation-correctness determining method includes detecting an operator's hand behavior with respect to the target object from time series variation of the detected target object and from time series variation of the detected operator's hand skeleton. The operator's hand behavior is a behavior of the hand of the operator, determining whether at least the detected target object and the detected operator's hand behavior with respect to the target object substantially match a pre-learned target object and a pre-learned operator's hand behavior with respect to the target object. The operation-correctness determining method includes, in a case where it is determined that the detected target object and the detected operator's hand behavior with respect to the target object substantially match the pre-learned target object and the pre-learned operator's hand behavior with respect to the target object, determining that the predetermined operation has been performed correctly. The pre-learned target object is the target object that is previously learned. The pre-learned operator's hand behavior is the operator's hand behavior that is previously learned.

An aspect of the disclosure provides an operation-correctness determining apparatus capable of determining whether a predetermined operation has been performed correctly. The predetermined operation is an operation that an operator performs on a target object defined in advance by hand. The operation-correctness determining apparatus includes a wearable camera, and circuitry. The wearable camera is capable of capturing a region larger than or substantially equal to a field of view of the operator. The circuitry is configured to detect the target object within a captured region captured by the wearable camera. The circuitry is configured to detect an operator's hand skeleton within the captured region. The operator's hand skeleton is a skeleton of a hand of the operator. The circuitry is configured to detect an operator's hand behavior from time series variation of the detected target object and from time series variation of the detected operator's hand skeleton. The operator's hand behavior is a behavior of the hand of the operator. The circuitry is configured to determine whether at least the detected target object and the detected operator's hand behavior substantially match a pre-learned target object and a pre-learned operator's hand behavior, upon determining that the detected target object and the detected operator's hand behavior substantially match the pre-learned target object and the pre-learned operator's hand behavior, the circuitry is configured to determine that the predetermined operation has been performed correctly. The pre-learned target object is the target object that is previously learned. The pre-learned operator's hand behavior is the operator's hand behavior that is previously learned.

### BRIEF DESCRIPTION OF THE DRAWINGS

The accompanying drawings are included to provide a further understanding of the disclosure and are incorporated in and constitute a part of this specification. The drawings illustrate an example embodiment and, together with the specification, serve to explain the principles of the disclosure.

FIG. 1 is a schematic perspective view of an automobile mass production process that employs an operation-correctness determining apparatus and an operation-correctness determining method according to an embodiment of the disclosure;

FIG. 2 illustrates an exemplary image captured during the production process illustrated in FIG. 1;

FIG. 3 illustrates detection of an operator's hand skeleton;

FIG. 4 is a flowchart of a learning procedure for the operation-correctness determining apparatus and the operation-correctness determining method illustrated in FIG. 1; and

FIG. 5 is a flowchart of a determination procedure for the operation-correctness determining apparatus and the operation-correctness determining method illustrated in FIG. 1.

### DETAILED DESCRIPTION

The conforming-item determination described in WO2018/062238A1, which determines whether a workpiece is a conforming item, is made by comparing a standard image of a conforming item with a workpiece image captured by the wearable camera. In this regard, as nonconformity conditions or workpiece types increase in complexity, such nonconformity conditions or workpiece types are to be learned extensively to allow such determination to be made. Use of artificial intelligence (to be abbreviated as AI hereinafter) with learning capability makes it possible to detect an object from an image (video), and detect the position of the object or label the object as to whether the object is a conforming item. There are currently attempts to use such AI capability to made a determination of whether an operation has been performed correctly on a target object (to be also referred to as “operation-correctness determination” hereinafter).

A predefined operation (predetermined operation) in manufacturing is generally performed by an operator by hand. Accordingly, a determination of whether a predetermined operation has been performed correctly on a target object can be made as described below. First, an image of the operator's hand and the target object when the predetermined operation is being performed correctly is captured by a wearable camera (a stationary camera may be used instead), and AI is made to learn the operator's hand and the target object within the captured image. Then, it is determined whether the operator's hand and the target object within a captured image captured during actual execution of the operation are present, for example, at the correct position and in the correct form. Whether the predetermined operation has been performed correctly can be determined based on the result of the above determination. In other cases, the operator's hand and the target object when the predetermined operation is being performed incorrectly are learned. As for the operator's hand, the position or shape (form) of the very hand within the image is learned.

The operation-correctness determination mentioned above, however, may still have some room for improvement. First, the operator's hand and the target object are to be extracted and learned with respect to each one of a large number of images (still images) cut out from a video. Second, for cases in which the determination is performed by learning the shape of the operator's hand, if, for example, the operator changes to another person, and the corresponding hand size thus changes to a different size, then a new hand with the different size is to be learned individually. Likewise, if the target object changes to another object, and the position or shape of the operator's hand changes accordingly, then relearning is to be performed in this case as well. It is therefore desirable to reduce the learning load associated with determining the correctness of an operation through image recognition.

It is desirable to provide an operation-correctness determining apparatus and an operation-correctness determining method that make it possible to reduce the learning load associated with determining the correctness of an operation through image recognition.

An operation-correctness determining apparatus and an operation-correctness determining method according to an embodiment of the disclosure are now described below in detail with reference to the drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

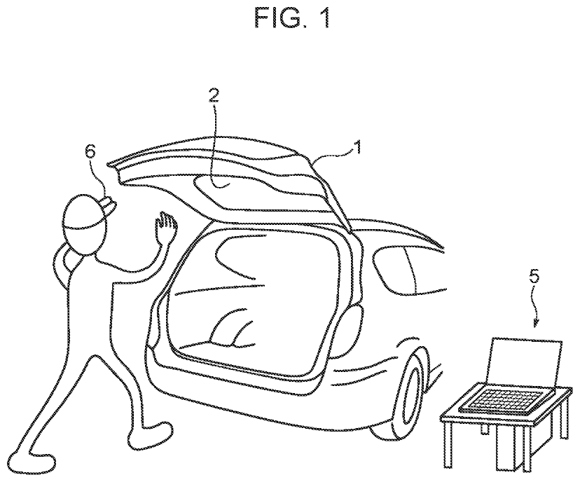

FIG. 1 is a schematic perspective view of an automobile mass production process that employs the operation-correctness determining apparatus and the operation-correctness determining method according to the embodiment. This process includes an operation of fitting a connector 3 on the cabin side of a rear gate 1 in the outfitting line for a vehicle such as a station wagon. The connector 3 is located slightly below a rear windshield 2 in the vertical direction of the vehicle. As illustrated in FIG. 1, the operation of fitting the connector 3 is performed from below the rear gate 1 with the rear gate 1 open.

The operation-correctness determining apparatus according to the embodiment is implemented by installing associated pieces of application software (to be referred to as “application” hereinafter) onto a personal computer (to be referred to as “PC” hereinafter) 5. Among these, a major piece of application software is an application incorporating AI with image recognition capability (to be also referred to as “image recognition AI” hereinafter). The PC 5 is a computer system with advanced processing capability. The PC 5 includes components such as a memory that stores a program, data, or other information, and an input/output device that receives a signal from external equipment such as a camera or a sensor or outputs a signal to external equipment such as a camera or a sensor. An application for skeleton detection described later may be, for example, an “unsupervised learning” application capable of detecting a skeleton simply by reading a video, or may be, for example, a “supervised learning” application that is trained with the positions of hand joints, and connects the joints by line segments to thereby detect a skeleton. It is to be noted that “detection” in image recognition is also referred to as “estimation (inference)”.

The operation-correctness determining apparatus according to the embodiment includes a wearable camera 6 that can be worn by an operator to acquire an image (video) of the connector 3, which is a target object, and of the operator's hand. It is desirable that the wearable camera 6 be able to capture a region larger than or substantially equal to the operator's field of view. Conceivably, the condition for the operator to correctly “fit the connector” is that the operator be able to see at least the “connector” and the “operator's own hand”, and the condition for determining whether such predetermined operation has been performed correctly is that the “connector” and the “operator's own hand” have been captured. According to the embodiment, to capture a region larger than or substantially equal to the operator's field of view, the wearable camera 6 is mounted on the top of the front visor of a cap worn by the operator. An image (video) signal from the wearable camera 6 is transmitted to the PC 5 by a known radio transmitter/receiver (not illustrated). The wearable camera 6 may not necessarily be mounted at the above-mentioned position. The image signal may be transmitted to the PC 5 by wire.

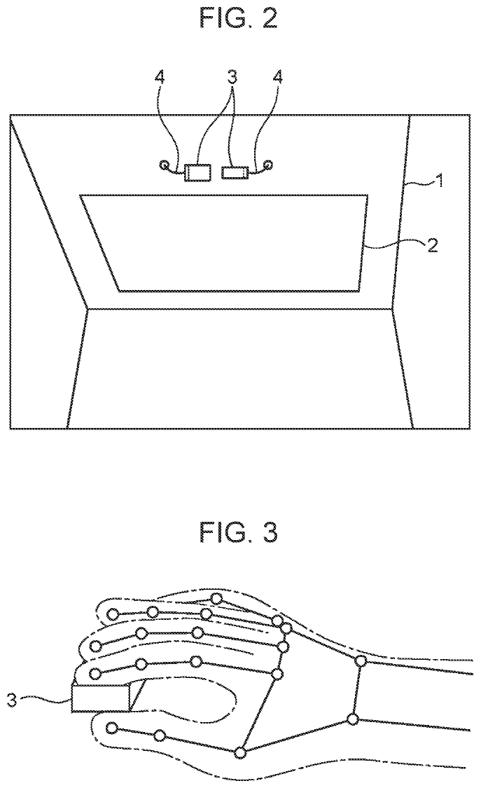

FIG. 2 illustrates an exemplary image that has been captured by the wearable camera 6 and read by the PC 5. The image is a schematic representation of an image of the rear gate 1 captured from below with the rear gate 1 open as mentioned above. A somewhat large quadrangle appearing in the central portion of FIG. 2 represents the rear windshield 2. Two small elongated quadrangles appearing slightly above the rear windshield 2 in the image each represent the connector 3. Line segments connected to the left and right of the connector 3 in the image each represent a harness 4 (wiring material). With the rear gate 1 closed, the connector 3 is located at a position on the vehicle below the rear windshield 2. With the rear gate 1 open and looked up from below at a position behind the vehicle, the connector 3 appears to be located above the rear windshield 2 in the resulting image. Accordingly, through image recognition, for example, the somewhat large quadrangular portion appearing in the central portion of the image can be detected as representing the rear windshield 2, and the two small elongated quadrangular portions appearing slightly above the large quadrangular portion can be detected as representing the connector 3. That is, the rear windshield 2 corresponds to a location (region) used in detecting the connector 3 (object), and the connector 3 (object), which is a target object, can be detected with reference to the location of the rear windshield 2. In addition to being provided with such information, for example, the image recognition AI may be taught to perform image recognition so as to recognize or determine the connector 3 as being “white” and “partially blue”. Such detection can be performed through the image recognition AI based on object detection, region estimation, or other techniques. One suitable example of such image recognition AI is a convolutional neural network. An object or region thus detected is represented by, for example, a quadrangular box enclosing the detected object or region. That is, such detected object or region exists within a quadrangular box recognized through image recognition.

FIG. 3 illustrates an image of an operator's hand that has been captured by the wearable camera 6 and read by the PC 5, and the skeleton of the hand detected from the image. A rectangular case at the left of FIG. 3 is a schematic representation of the connector 3. In FIG. 3, the outline of the hand in the image is represented by an alternate long and short dash line, the positions of the joints are represented by open circles, and the skeleton is represented by straight line segments. Nowadays, use of skeleton detection based on image recognition is becoming a common sight in the field of television broadcasting or telecommunications. Such skeleton detection based on image recognition includes detecting human body joints, and connecting the joints by line segments to detect a skeleton (also called a skeleton line model). The skeleton detection based on image recognition makes it possible to, for example, individually detect the skeletons of multiple human bodies that appear overlapping in an image. Therefore, such skeleton detection makes it possible to detect even what has hitherto been undetectable, that is, the skeleton of a human body portion that does not appear clearly in an image.

For example, the skeleton of a hand pinching the connector 3 with the fingertips is roughly the same in form from person to person. The form of the skeleton is roughly the same across variations in hand size among different operators. Further, there is not much variation of the posture of the operator fitting the connector 3 toward the rear gate 1 that has been opened as mentioned above, nor is there much variation of the orientation of the hand appearing in a captured image. This means that by tracking and analyzing time series variation of the operator's hand skeleton for the duration of time that the operator is considered to be fitting the connector 3, the behavior of the hand in fitting the connector 3 can be recognized or detected. Accordingly, whether a connector-fitting operation has been performed correctly can be determined as described below. First, a hand behavior obtained from time series variation of a hand skeleton during execution of a correct connector-fitting operation is learned. Then, during the actual connector-fitting operation, with the connector 3 continuing to be detected, if a hand behavior that substantially matches the learned hand behavior is detected at the correct position, then the connector-fitting operation is determined to have been performed correctly. For such time series information processing, for example, AI such as a recursive neural network can be employed. Since time series information is used, the timing of a hand behavior can be also detected or determined. Therefore, for cases in which the timing at which to perform a predetermined operation is specified, it is also possible to determine whether the timing of such predetermined operation is correct.

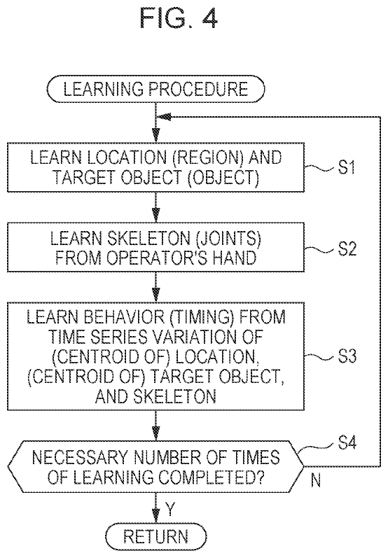

FIG. 4 is a flowchart of a learning procedure executed by the AI-incorporated application installed on the PC 5. Although the flowchart illustrates supervised learning in which the application is taught a necessary number of times of learning, it is also possible to employ unsupervised learning or deep learning in which learning is directed by the application itself. The learning procedure begins at step S1 where, from an image (video) captured by the wearable camera 6 and read by the PC 5, a location (region) at which to perform a predetermined operation, and a target object (object) on which to perform the predetermined operation are learned. According to the embodiment, the rear windshield 2 in the image is learned as the above-mentioned (reference) location, and the connector 3 is learned as the above-mentioned target object. The learned location (region) and the learned target object (object) are each extracted in the quadrangular box mentioned above. The image (video) to be used for learning may not necessarily be an image (video) captured by the wearable camera 6. Alternatively, such image may be, for example, an image (video) of a similar region captured by another, stationary camera.

The procedure then transfers to step S2 where a skeleton is learned similarly from the operator's hand within the image. In that case, as described above, the skeleton may be learned by the AI-incorporated application by detecting skeleton lines, or may be learned by teaching joints and connecting the joints by line segments. Such skeleton learning may as well be performed by using a hand other than the actual operator's hand. As described above, given the fact that the hand to be learned changes to another hand as the operator changes to another person, it is desirable to perform skeleton learning with the same operation performed with various hands, including those of artificial images.

The procedure then transfers to step S3 where a hand behavior is learned from time series variation of the location and the target object detected at step S1, and from time series variation of the hand skeleton detected at step S2. The hand behavior to be learned in this case is, for example, the behavior of the hand in fitting the connector. As for the time series variation of the location and the target object, time series variation of the centroid (barycenter) of the above-mentioned quadrangular box may be used. Further, as described above, in learning a hand behavior, the timing of the hand behavior may be learned together with the hand behavior.

The procedure then transfers to step S4 where it is determined whether a necessary number of times of learning have been completed. The procedure returns if a necessary number of times of learning have been completed. Otherwise, the procedure transfers to step S1 mentioned above.

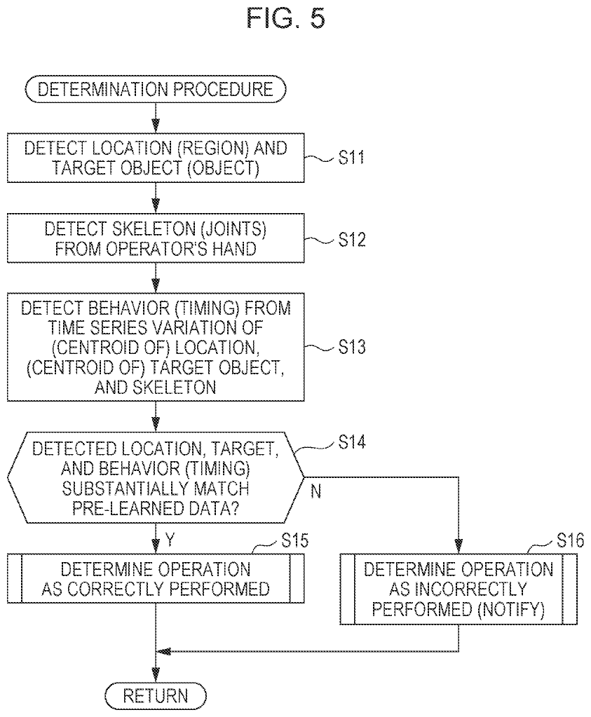

FIG. 5 is a flowchart of the procedure for operation-correctness determination executed by the AI-incorporated application installed on the PC 5. The procedure for operation-correctness determination begins at step S11 where, from an image (video) captured by the wearable camera 6 and read by the PC 5, a location (region) at which to perform a predetermined operation, and a target object (object) on which to perform the predetermined operation are detected. According to the embodiment, the rear windshield 2 in the image is detected as the above-mentioned (reference) location, and the connector 3 is detected as the above-mentioned target object. The detected location (region) and the detected target object (object) are each extracted in the quadrangular box mentioned above.

The procedure then transfers to step S12 where a skeleton is detected similarly from the operator's hand within the image. This may be performed by, instead of directly detecting the skeleton, detecting the joints of the hand and connecting the joints by line segments.

The procedure then transfers to step S13 where a hand behavior is detected from time series variation of the location and the target object detected at step S11, and from time series variation of the hand skeleton detected at step S12. As for the time series variation of the location and the target object, time series variation of the centroid (barycenter) of the above-mentioned quadrangular box may be used. Further, as described above, in detecting a hand behavior, the timing of the hand behavior may be detected together with the hand behavior.

The procedure then transfers to step S14 where it is determined whether the location and the target object detected at step S11, and the hand behavior (timing) detected at step S13 substantially match the corresponding pre-learned data. The procedure transfers to step S15 if the detected data and the pre-learned data substantially match. Otherwise, the procedure transfers to step S16.

At step S15 mentioned above, it is determined that the predetermined operation has been performed correctly on the target object, and then the procedure returns. The above-mentioned determination that the operation has been performed correctly may, for example, be accompanied by an individual process in the vehicle outfitting line, such as automatically transporting a vehicle for which the predetermined operation has been completed to the next production step.

At step S16 mentioned above, it is determined that the predetermined operation has not been performed correctly on the target object, and then the procedure returns. The above-mentioned determination that the operation has not been performed correctly may, for example, be accompanied by notification provided via, for example, a display, a signal lamp, or a buzzer to indicate that the operation has not been performed correctly. The above-mentioned determination may, for example, be accompanied by an individual process in the vehicle outfitting line, such as not automatically transporting a vehicle to the next production step even after the completion of the operation.

Through the computational processing mentioned above, a location (rear windshield 2) and a target object (connector 3) are detected from an image of a region larger than or substantially equal to the field of view of an operator, and a behavior of an operator's hand is detected from time series variation of the skeleton of the operator's hand appearing in the image. If these pieces of detected data substantially match the corresponding pieces of pre-learned data, it is determined that the operation of fitting the connector 3 of the rear gate 1 has been performed correctly. Otherwise, it is determined that the operation has not been performed correctly. Among the above-mentioned pieces of data, the location, that is, the rear windshield 2, and the target object, that is, the connector 3, can be detected with improved accuracy through object detection, region estimation, or other techniques. Further, as described above, the skeleton of a hand during execution of a predetermined operation on the target object does not vary very much among different operators, nor does the orientation of a hand during execution of a predetermined operation performed in a similar posture vary very much among different operators. Accordingly, for example, if the skeletons or orientations of several hands, and hand behaviors based on their time series variation are learned, the resulting learning load is significantly less relative to the load of learning the positions or shapes of various hands through object detection or other techniques. For example, although learning of the positions or shapes of various hands through object detection is to be performed for each one of a large number of images cut out from a video, for example, substantially consecutive images, hand skeletons and hand behaviors based on their time series variation can be learned or detected with improved accuracy even if these pieces of data are discrete to some extent. That is, with hand skeleton detection and hand behavior learning based on time series variation of such detected hand skeleton, the associated learning load is accordingly less than the load of learning the positions or shapes of hands through object detection. Such hand behavior learning or detection can be performed similarly even if the target object changes somewhat, for example, even if the size of the connector 3 changes slightly.

As described above, with the operation-correctness determining apparatus and the operation-correctness determining method according to the embodiment, a target object and an operator's hand skeleton within a captured region captured by the wearable camera 6 can be detected through image recognition, and a hand behavior with respect to the target object can be detected through image recognition from time series variation of the detected target object and from time series variation of the detected hand skeleton. The operator's hand skeleton detected at this time, which is detected through image recognition and representative of the skeleton of the user' hand during execution of a predetermined operation, remains roughly the same even if the shape of the operator's hand such as its size changes to some extent. Consequently, even if the operator changes to another person, a hand behavior detected from time series variation of the operator's hand skeleton can be detected similarly through learning. Likewise, even if the target object changes to some extent, as long as the kind of the predetermined operation to be performed is substantially the same, then a hand behavior with respect to the target object can be detected similarly. As for the target object to be detected through image recognition (object detection), such target object itself, including its positional information, can be detected with improved accuracy. Accordingly, if the target object and the operator's hand behavior substantially match the corresponding pre-learned data, then it can be determined that the predetermined operation has been performed correctly on the target object. This may reduce relearning that may otherwise be performed in operation-correctness determination if the operator's hand shape changes to some extent or if the target object changes to some extent. This may reduce the associated learning load accordingly.

If the predetermined operation mentioned above is to be performed at a predetermined location, the predetermined location within a captured region, which is the location at which to perform the predetermined operation, can be detected through image recognition (object detection or region estimation). Accordingly, the predetermined operation is determined to have been performed correctly if the learned operator's hand behavior mentioned above is detected at the predetermined location. At this time, if the predetermined location at which to perform the predetermined operation changes to another new location, it may suffice to simply learn the image recognition results for the new location. This may reduce the load of learning associated with, for example, relearning the operator's hand (such as its position or shape) at the new location all over again.

If the predetermined operation mentioned above is to be performed at a predetermined timing, the timing of an operator's hand behavior is detected from time series variation of the operator's hand skeleton mentioned above, and if the timing of the operator's hand behavior substantially matches a pre-learned predetermined timing, then the predetermined operation is determined to have been performed correctly. This allows the operation-correctness determination to be made by taking the operator's hand behavior into account. Therefore, also for cases in which the timing at which to perform a predetermined operation is specified, the determination of whether the operation has been performed correctly can be made with improved accuracy.

If the predetermined operation mentioned above has been performed incorrectly, an indication to that effect is provided to help prevent or reduce defects that may occur in mass automobile production or other industries.

Although the operation-correctness determining apparatus and the operation-correctness determining method according to the embodiment have been described above, the disclosure is not limited to the details described with reference to the above embodiment but may include various modifications that may fall within the scope of the disclosure. For example, according to the above embodiment, a location is learned to determine whether a predetermined operation has been performed correctly on a target object, and correctness determination is performed also with respect to the location. Further, where appropriate, the timing of a hand behavior is learned, and correctness determination can be performed also with respect to the timing of the hand behavior. In this regard, in its simplest form, the operation-correctness determination according to the embodiment may simply detect a target object, and determine whether a predetermined operation has been performed correctly on the target object. Therefore, the above-mentioned location and timing can be said to be optional matters for the operation-correctness determination.

Likewise, although the foregoing description is directed to a case in which, if a predetermined operation has not been performed correctly on a target object, notification to that effect is provided, such notification of an incorrectly performed operation may not be provided. For example, if a vehicle is not automatically transported to the next production step even after completion of a predetermined operation in the vehicle outfitting line, then it can be recognized that the predetermined operation has not been performed correctly.

Although the foregoing detailed description of the embodiment is directed to the operation of fitting the connector 3 of the rear gate 1 of the vehicle in the vehicle outfitting line, the operation-correctness determining apparatus and the operation-correctness determining method according to the embodiment of the disclosure are applicable to any type of operation performed in any type of business that is generally related to manufacturing.

As described above, according to an embodiment of the disclosure, whether a predetermined operation has been performed correctly on a target object can be determined with improved accuracy through image recognition, and the learning load associated with, for example, relearning performed if the target object or the operator's hand changes to some extent can be reduced.

The PC 5 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the PC 5. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the PC 5 in FIG. 1.

1. An operation-correctness determining apparatus capable of determining whether a predetermined operation has been performed correctly, the predetermined operation being an operation that an operator performs on a target object defined in advance by hand, the operation-correctness determining apparatus comprising:
a wearable camera capable of capturing a region larger than or substantially equal to a field of view of the operator;
a target object detector configured to detect the target object within a captured region captured by the wearable camera;
a hand skeleton detector configured to detect an operator's hand skeleton within the captured region, the operator's hand skeleton being a skeleton of a hand of the operator;
a motion detector configured to detect an operator's hand behavior from time series variation of the target object detected by the target object detector and from time series variation of the operator's hand skeleton detected by the hand skeleton detector, the operator's hand behavior being a behavior of the hand of the operator; and
an operation-correctness determiner configured to determine whether at least the target object detected by the target object detector and the operator's hand behavior detected by the motion detector substantially match a pre-learned target object and a pre-learned operator's hand behavior, and to, upon determining that the detected target object and the detected operator's hand behavior substantially match the pre-learned target object and the pre-learned operator's hand behavior, determine that the predetermined operation has been performed correctly, the pre-learned target object being the target object that is previously learned, the pre-learned operator's hand behavior being the operator's hand behavior that is previously learned.

2. The operation-correctness determining apparatus according to claim 1,
wherein in a case where the predetermined operation is to be performed at a predetermined location,
the target object detector is configured to detect the predetermined location within the captured region captured by the wearable camera, and
the operation-correctness determiner is configured to, in response to the pre-learned operator's hand behavior being detected at the predetermined location detected by the target object detector, determine that the predetermined operation has been performed correctly.

3. The operation-correctness determining apparatus according to claim 1,
wherein in a case where the predetermined operation is to be performed at a predetermined timing,
the motion detector is configured to detect a timing of the operator's hand behavior, and
the operation-correctness determiner is configured to, in a case where the timing of the operator's hand behavior detected by the motion detector substantially matches a pre-learned predetermined timing, determine that the predetermined operation has been performed correctly, the pre-learned predetermined timing being the predetermined timing that is previously learned.

4. The operation-correctness determining apparatus according to claim 2,
wherein in a case where the predetermined operation is to be performed at a predetermined timing,
the motion detector is configured to detect a timing of the operator's hand behavior, and
the operation-correctness determiner is configured to, in a case where the timing of the operator's hand behavior detected by the motion detector substantially matches a pre-learned predetermined timing, determine that the predetermined operation has been performed correctly, the pre-learned predetermined timing being the predetermined timing that is previously learned.

5. The operation-correctness determining apparatus according to claim 1, wherein the operation-correctness determiner comprises a notifier configured to, in a case where the predetermined operation has been performed incorrectly, provide notification indicating that the predetermined operation has been performed incorrectly.

6. The operation-correctness determining apparatus according to claim 2, wherein the operation-correctness determiner comprises a notifier configured to, in a case where the predetermined operation has been performed incorrectly, provide notification indicating that the predetermined operation has been performed incorrectly.

7. The operation-correctness determining apparatus according to claim 3, wherein the operation-correctness determiner comprises a notifier configured to, in a case where the predetermined operation has been performed incorrectly, provide notification indicating that the predetermined operation has been performed incorrectly.

8. The operation-correctness determining apparatus according to claim 4, wherein the operation-correctness determiner comprises a notifier configured to, in a case where the predetermined operation has been performed incorrectly, provide notification indicating that the predetermined operation has been performed incorrectly.

9. An operation-correctness determining method for determining whether a predetermined operation has been performed correctly, the predetermined operation being an operation that an operator performs on a target object defined in advance by hand, the operation-correctness determining method comprising:
detecting the target object within a captured region captured by a wearable camera, the wearable camera being capable of capturing a region larger than or substantially equal to a field of view of the operator;
detecting an operator's hand skeleton within the captured region, the operator's hand skeleton being a skeleton of a hand of the operator;
detecting an operator's hand behavior with respect to the target object from time series variation of the detected target object and from time series variation of the detected operator's hand skeleton, the operator's hand behavior being a behavior of the hand of the operator; and
determining whether at least the detected target object and the detected operator's hand behavior with respect to the target object substantially match a pre-learned target object and a pre-learned operator's hand behavior with respect to the target object, and in a case where it is determined that the detected target object and the detected operator's hand behavior with respect to the target object substantially match the pre-learned target object and the pre-learned operator's hand behavior with respect to the target object, determining that the predetermined operation has been performed correctly, the pre-learned target object being the target object that is previously learned, the pre-learned operator's hand behavior being the operator's hand behavior that is previously learned.

10. An operation-correctness determining apparatus capable of determining whether a predetermined operation has been performed correctly, the predetermined operation being an operation that an operator performs on a target object defined in advance by hand, the operation-correctness determining apparatus comprising:
a wearable camera capable of capturing a region larger than or substantially equal to a field of view of the operator; and
circuitry configured to
detect the target object within a captured region captured by the wearable camera,
detect an operator's hand skeleton within the captured region, the operator's hand skeleton being a skeleton of a hand of the operator,
detect an operator's hand behavior from time series variation of the detected target object and from time series variation of the detected operator's hand skeleton, the operator's hand behavior being a behavior of the hand of the operator,
determine whether at least the detected target object and the detected operator's hand behavior substantially match a pre-learned target object and a pre-learned operator's hand behavior, and
upon determining that the detected target object and the detected operator's hand behavior substantially match the pre-learned target object and the pre-learned operator's hand behavior, determine that the predetermined operation has been performed correctly, the pre-learned target object being the target object that is previously learned, the pre-learned operator's hand behavior being the operator's hand behavior that is previously learned.
